(19) United States
(12) Patent Application Publication
(10) Pub. No.: US 2015/0096502 A1
(43) Pub. Date: Apr. 9, 2015

(54) DOG LEASH AND RUN SYSTEM

(71) Applicant: Frederick T. Weston, Bloomfield Hills, MI (US)

(72) Inventor: Frederick T. Weston, Bloomfield Hills, MI (US)

(21) Appl. No.: 13/828,569

(22) Filed: Mar. 14, 2013

(51) Int. Cl. A01K 1/04

(52) U.S. Cl. CPC A01K 1/04
USPC 119/785

(57) ABSTRACT

A dog leash and run restraint system which allows significant area of movement for a dog in a backyard or other area. A pulley member is positioned on a main line that is connected between two support structures, such as between a house and a tree. An retractable leash mechanism is attached to the pulley member. A protective housing member for the pulley member can also be provided. Stop members can be positioned on the main line to limit movement of the pulley member.

### TECHNICAL FIELD

The present invention relates to leash-type restraint systems for dogs, and more particularly to a system which allows the dogs to move throughout a large area.

### BACKGROUND

There are many devices used to restrain dogs to keep them under control or within a certain area. These devices and systems include structural forces, hand leashes, “invisible” fences, dog runs and the like. Each of these has one or more disadvantages. Many do not allow the dogs to have a significant area in which to roam. The “invisible” fenses often shock the dogs, and do not prevent them from running through the electric field when excited. Other systems involve constant human interaction or observation.

There is a need for a restraint-apparatus and system which allows dogs to run and roam in a large area that does not injure the dogs, prevents the dogs from leaving a certain area, and does not need human interaction or observation.

### SUMMARY OF THE INVENTION

The present invention provides a unique and beneficial apparatus and system which does not have any of the drawbacks of these systems. The system includes a long main wire or rope (called a “main line”) which can be placed entirely across a yard or open area in order to provide a large area for the dogs to run or roam. A retractable leash mechanism is positioned on the main line and attached thereto with a pulley member and a detachable clip member. The pulley member is positioned on the main line and the retractable leash mechanism is connected to the pulley member with the detachable clip member.

The retractable leash mechanism has a housing with an elongated strap or leash. A clip-fastener device is attached at the distal end of the leash can be extended from the housing, A spring biased retractable mechanism in the housing applies a consistent force in the direction of retraction of the leash. The clip-fastener device at the end is used to connect to the dog, particularly on a collar.

With the invention, the dog can roam along the longitudinal length of the main line, as well as transversely to the full extension of the retractable leash. One or more stop members can also be provided and secured to the main line to limit the extent of range of the dog in order to protect certain shrubbery, flower beds or the like.

A cover can be provided to fit over or around the pulley member. This provides additional protection to maintain the pulley member on the main line, and also helps protect the pulley member from the weather and other environmental elements.

Further objects, features and benefits of the invention are set forth below in the following description of the invention when viewed in combination with the drawings and appended claims.

### BRIEF DESCRIPTION OF THE DRAWINGS

FIG. 1 is a schematic illustration of an embodiment of the inventive system.

FIG. 2 is an elongated view of the area “2” in FIG. 1.

FIG. 3 is an elongated view of the end of a retractable leash connected to the collar of a dog.

FIG. 4 is a schematic illustration of the area in which a dog can run and roam in accordance with an embodiment of the invention.

FIG. 5 schematically depicts an embodiment of a stop member.

### DESCRIPTION OF THE PREFERRED EMBODIMENTS

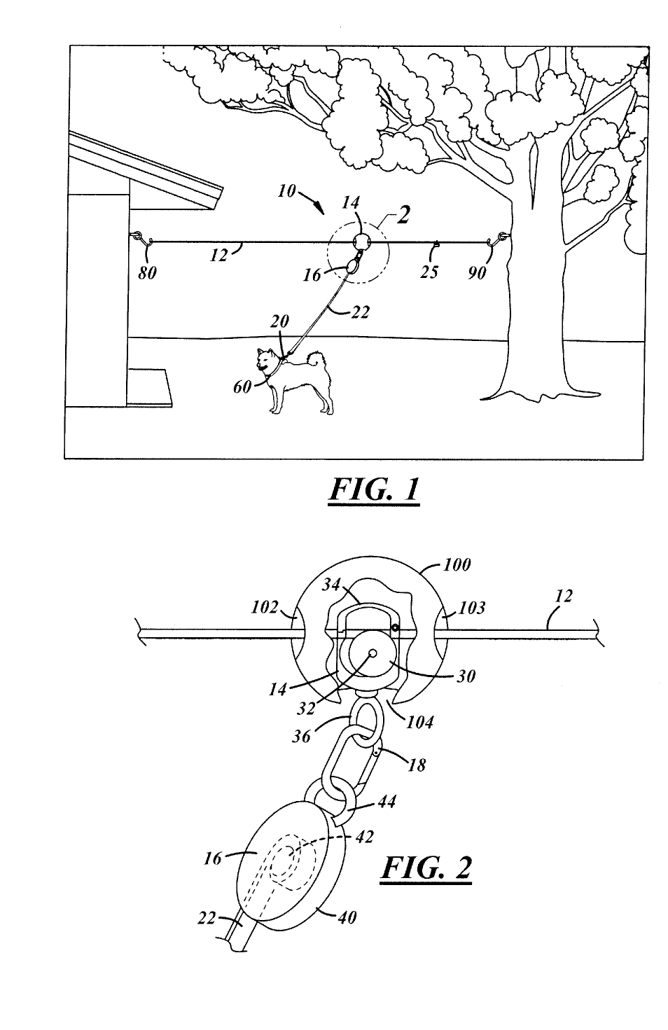

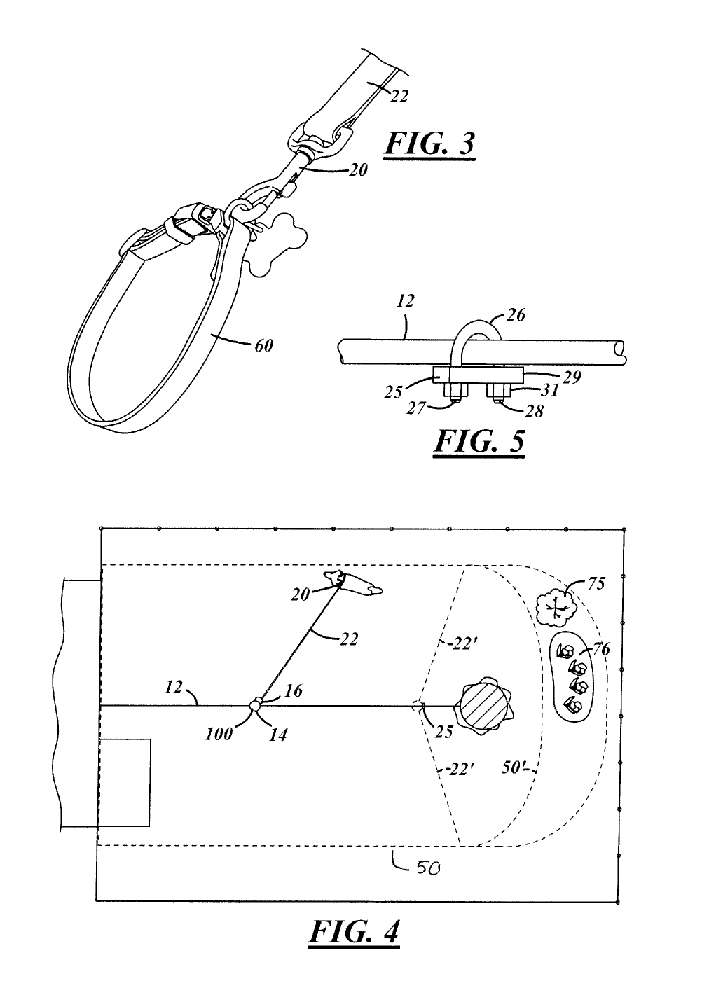

A preferred embodiment of the present invention is depicted in FIG. 1 and designed by the reference numeral 10. The system 10 includes a main line 12, a pulley member 14, a retractable leash mechanism 16, a first detachable fastener 18 positioned between the pulley member 14 and the extendable leash mechanism 16, and a second detachable fastener 20 attached to the distal end of the extendable leash 22. A stop member 15 is optional.

The main line 12 is preferably a wire or rope of some type (e.g. clothes line). It should be sufficiently sturdy and durable to endure the outdoor environment and weather, as well as to accommodate the strains and forces applied to it by dogs who are connected to the system.

The pulley member can be any conventional type, but preferably is the type shown in the drawings. The pulley member should be as lightweight as possible, and yet have sufficient strength and durability to handle the forces and environmental conditions that are experienced by the system. The pulley member shown in the drawings has a central wheel-type member 30 which rotates around a pin member 32 and includes a releasable hook member 34 (used to hold the pulley in place on the main line). The releasable hook member 34 allows the pulley members to be attached and detached to an existing wire or rope, or removed or reattached as desired by the dog owner. A ring or loop 36 is also preferably included on the pulley member in order to accommodate the fastener member 18 which is adapted to connect the pulley members to the retractable leash mechanism 16.

In a preferred embodiment, the fastener member 16 includes a housing member 40 and an extendable strap or leash member 22 positioned around a spool 42 or the like positioned on the housing member. The housing has a spring biased retractable mechanism (not shown) attached to the spool 42 which applies a constant force in the direction of retracting the leash member 22 back into the housing member 40. Extendable (a/k/a “retractable”) leash mechanisms of this type are available today in pet stores and the like, and are provided under trade names such as Flexi Freedom and Nicole Miller.

The available retractable leash devices typically have a handle to allow easy and secure grasping when a person is walking a dog. In the embodiment shown, the housing member has a ring member 44 attached to it so that it can be easily connected to the fastener member 18. With this embodiment, the extendable leash mechanism 16 can be detached from the pulley member 14 and then used by the dog owner to manually walk the dog.

In another embodiment, the retractable leash mechanism can be attached permanently to the pulley member.

The extendable leash member 22 in the retractable leash mechanism 16 can have any desired length. Available retractable devices have extendable leashes 10 ft. to 26 ft. in length The extendable leash members allow the dog to be able to roam a considerable distance transverse to the main line 12. In this regard, FIG. 4 depicts a possible area 50 of roaming for a dog attached to the system 10. The roaming area 50 provides a significant space and area for the dog to roam in a backyard or other area.

Due to the biased retraction force on the leash 22 by the retractable leash mechanism 16, the dog will always have a slight pulling force on its collar 60. This prevents the leash from being dragged through mud or other matter on the ground, and also prevents the leash from being caught or “hung up” by bushes, branches, lawn furniture, or the like positioned in the area 50.

The detachable fastener 20 is used to connect the extendable leash member 22 to the dog collar 60. The fastener 20 can be any conventional type of fastener, but preferably is a clip-type fastener which can be easily attached and detached from the collar. In this manner, the dog can be easily and quickly connected and disconnected from the system 10.

The main line 12 can be of any desired length and can be attached in any manner at its two ends. In the illustration depicted in FIG. 1, one end of the line 12 is attached by a hook 80 to a house and the other is attached by a hook 90 to a tree. It is obvious that the main line can be extended between any structure in the area (house, garage, children's play structure, large bush, tree, etc.) Also, the main line could simply be strung between two poles that are embedded into the ground or secured in permanent or movable pole bases.

The embodiment depicted in the drawings also includes a housing member 100 which is positioned over the pulley member 14. The housing member 100 protects the pulley member and its attachment to the first fastening member 18 from the rain, sun, snow, and other environmental conditions. The housing member 100 also can add aesthetics to the system 10 and make it look more attractive.

In the drawings, the housing member 100 has a ball or spherical shape, although the size and shape is not critical. The housing member 100 also can be made of a two-part plastic material that snaps together around the pulley member. As indicated, a plurality of openings 102, 103, 104 are provided in the housing member in order to accommodate the main line 12 and access to the fastening member 18 and retractable leash mechanism 16.

One or more stop members 25 can be utilized in order to selectively limit the extent of area in which the dog can roam. This will allow the dog owner to protect, for example, bushes, flowers, bird baths, and the like from attention or damage by the dog. An embodiment of a stop member 25 which can be utilized with the system 10 is shown in FIG. 5. The stop member includes a U-shaped member 26 with two threaded ends 27, 28 which fit through a plate member 29 and secured with nuts or the like 31. The stop member 25 can be positioned at any location along the main line 12 in order to restrict movement of the pulley member (and housing member 100) along the main line.

A practical embodiment showing use of a stop member 25 is shown in FIG. 4. The stop member 25 limits the dog to the area shown in 50′ and prevents the dog from approaching items such as a bush 75, a flower bed 76 or the like.

Although the invention has been described with respect to preferred embodiments, it is to be also understood that it is not to be so limited since changes and modifications can be made therein which are within the full scope of this invention as detailed by the following claims.

1. (canceled)

2. (canceled)

3. (canceled)

4. (canceled)

5. (canceled)

6. (canceled)

7. (canceled)

8. (canceled)

9. (canceled)

10. (canceled)

11. The dog leash run system as described in claim 12 further comprising at least one stop member, said stop member adapted for selective attachment to said main line in order to limit movement of said pulley member.

12. A dog leash and run system comprising:
a main line comprising a wire or rope member;
a spherical housing member positioned on said main line;
a pulley member for positioning on said main line and moveable therealong;
said pulley member positioned inside said spherical housing member;
a first detachable fastening member attached to said pulley member;
a pair of aligned openings in said housing member for positioning of said main line through said housing member;
a third opening in said housing member substantially orthogonal to said pair of aligned openings;
said first detachable fastening member attached to said pulley member through said third opening;
a retractable leash mechanism detachably secured to said first detachable fastener member;
said retractable leash mechanism comprising a leash member with a second retractable fastener member at the distal end thereof.

13. A dog leash and run system as described in claim 12 further comprising said main line having releasable connection member at each end.

14. The dog leash and run system as described in claim 12 wherein said spherical housing member comprises a two-piece plastic housing member.
